(19) United States
(12) Patent Application Publication
(10) Pub. No.: US 2025/0158105 A1
(43) Pub. Date: May 15, 2025

(54) LITHIUM-ION SECONDARY BATTERY

(71) Applicant: TOYOTA JIDOSHA KABUSHIKI KAISHA, Toyota-shi (JP)

(72) Inventors: Ryo ASAKURA, Shizuoka-ken (JP); Shinya SHIOTANI, Nagoya-shi (JP); Sakina KANEKO, Fujisawa-shi (JP)

(73) Assignee: TOYOTA JIDOSHA KABUSHIKI KAISHA, Toyota-shi (JP)

(21) Appl. No.: 18/765,558

(22) Filed: Jul. 8, 2024

(30) Foreign Application Priority Data
Nov. 14, 2023 (JP) 2023-193413

(51) Int. Cl. H01M 10/0525; H01M 4/134; H01M 4/36; H01M 4/38; H01M 10/0562; H01M 10/0585

(52) U.S. Cl. CPC H01M 10/0525; H01M 4/134; H01M 4/366; H01M 4/38; H01M 4/387; H01M 10/0562; H01M 10/0585; H01M 2300/0068

(57) ABSTRACT

A lithium-ion secondary battery that utilizes metal lithium deposition-dissolution reactions includes a cathode layer, an anode layer and an electrolyte layer between the cathode layer and the anode layer, the cathode layer includes a cathode active material that is arranged to absorb and desorb lithium ions, the anode layer includes a silver (Ag) element, a tin (Sn) element, and a lithium (Li) element, and a molar ratio of the Sn element to the Ag element (Sn/Ag) contained in the anode layer is 0.09 or higher and 0.17 or lower.

### CROSS-REFERENCE TO RELATED APPLICATION

This application claims priority to Japanese Patent Application No. 2023-193413 filed on Nov. 14, 2023, incorporated herein by reference in its entirety.

### BACKGROUND

### 1. Technical Field

The present disclosure relates to a lithium-ion secondary battery.

### 2. Description of Related Art

Various types of technology have been proposed for a lithium-ion secondary battery including a metal layer in an anode, such as disclosed in Japanese Unexamined Patent Application Publication No. 2021-068706 (JP 2021-068706 A).

### SUMMARY

In the related art, resistance of an anode layer increases toward the end of discharge of the lithium-ion secondary battery, and accordingly reversible capacity of the lithium-ion secondary battery decreases with repeated charging and discharging.

The present disclosure has been made in view of the above circumstances, and a primary object thereof is to provide a lithium-ion secondary battery capable of suppressing decrease in reversible capacity.

That is to say, the present disclosure includes the following aspects.
<1> A lithium-ion secondary battery utilizes metal lithium deposition-dissolution reactions. The lithium-ion secondary battery includes a cathode layer, an anode layer, and an electrolyte layer between the cathode layer and the anode layer, in which
the cathode layer includes a cathode active material that is arranged to absorb and desorb lithium ions,
the anode layer includes a silver (Ag) element, a tin (Sn) element, and a lithium (Li) element, and
a molar ratio of the Sn element to the Ag element (Sn/Ag) contained in the anode layer is 0.09 or higher and 0.17 or lower.

In the lithium-ion secondary battery according to <1>,
<2> the lithium-ion secondary battery includes an anode current collector on an opposite side of the anode layer from the electrolyte layer, and
when the anode layer is equally divided into two parts parallel to a layer surface of the anode layer, and a region on a side of the anode current collector is defined as a first region and a region on a side of the electrolyte layer is defined as a second region, content of the Sn element in the second region of the anode layer is greater than content of the Sn element in the first region of the anode layer.

In the lithium-ion secondary battery according to <1> or <2>,
<3> when the lithium-ion secondary battery is fully charged, a composition ratio of Li in an Li—Ag alloy produced in the anode layer is 94 mol % or more and 97 mol % or less.

In the lithium-ion secondary battery according to any one of <1> to <3>,
<4> the electrolyte layer is a solid electrolyte layer containing a sulfide-based solid electrolyte.
<5> A lithium-ion secondary battery utilizes metal lithium deposition-dissolution reactions.

The lithium-ion secondary battery includes a cathode layer, an anode layer, and an electrolyte layer between the cathode layer and the anode layer, in which
the cathode layer includes a cathode active material that is arranged to absorb and desorb lithium ions,
the anode layer includes a metal Sn layer containing elemental Sn, and a metal Ag layer containing elemental Ag in order from a side of the electrolyte layer, and
a molar ratio of an Sn element to an Ag element (Sn/Ag) contained in the anode layer is 0.09 or higher and 0.17 or lower.

The lithium-ion secondary battery according to the present disclosure can suppress decrease in reversible capacity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of a lithium-ion secondary battery before initial charging at the time of manufacturing of the present disclosure;

FIG. 2 is a schematic cross-sectional view showing an example of a lithium-ion secondary battery at the time of full charge after initial charge according to the present disclosure;

FIG. 3 is a graphical representation of the resistivity of the laminated cell after initial charge-discharge with Li content in Li—Ag layers;

FIG. 4 is a graph showing the relation between the reversible capacitance at 25° C. of the laminated cells after the charge-discharge cycles of Example 1 to 2 and Comparative Example 1 to 2;

FIG. 5 is a SEM-EDX mapping of the cross section of the solid electrolyte layer-anode after the first charge of Example 2, wherein (1) the secondary electronic image, (2) the S element mapping, (3) Ag element mapping, (4) Sn element mapping, (5) Ni element mapping, and (6) the O element mapping; and

FIG. 6 shows (1) a secondary electronic image, (2) an S-element mapping, (3) Ag element mapping, (4) Sn element mapping, (5) Ni element mapping, and (6) O-element mapping in SEM-EDX mapping of the solid electrolyte layer-anode cross-section after the first discharging of Example 2.

### DETAILED DESCRIPTION OF EMBODIMENTS

Hereinafter, embodiments according to the present disclosure will be described. Note that matters other than those specifically mentioned in the present specification and necessary for the implementation of the present disclosure can be understood as design matters of a person skilled in the art based on the prior art in the field. The above needs are, for example, general configurations and manufacturing processes for lithium-ion secondary batteries that do not characterize the present disclosure. The present disclosure can be carried out based on content disclosed in the present specification and common knowledge in the technical field.

In the present disclosure, a lithium-ion secondary battery using a precipitation-dissolution reaction of metal lithium is provided.

The lithium-ion secondary battery includes a cathode layer, an anode layer, and an electrolyte layer between the cathode layer and the anode layer, in which
the cathode layer includes a cathode active material that is arranged to absorb and desorb lithium ions,

The anode layer includes an Ag element, a Sn element, and a Li element,

The molar ratio (Sn/Ag) of Sn element to Ag element contained in the anode layer is 0.09 to 0. A lithium-ion secondary battery is provided which is 17 or less.

In the present disclosure, it is possible to suppress an increase in the resistance of the anode layer in the end-of-discharge period and to suppress a decrease in the charge-discharge efficiency. Since the melting point of Sn is low, the adhesion between the electrolyte layer and the anode layer is high, and a decrease in charge-discharge efficiency can be suppressed.

Li—Sn layer is formed between the electrolyte layer and Li—Ag layer when Li is inserted into the anode layer, whereby the anode layer can be prevented from being peeled from the electrolyte layer. As compared with the case where Li—Ag layers are not provided or the case where Li—Ag layers are used, the resistivity of the lithium-ion secondary batteries can be reduced at the end of discharge, the reversible capacitance can be increased, and the charge/discharge efficiency can be improved.

When Sn is mixed with Ag alone, the melting point becomes lower, the adhesion between the electrolyte layer and the anode layer becomes higher, and it is possible to suppress the anode layer from being peeled off from the electrolyte layer.

The lithium-ion secondary battery of the present disclosure utilizes a deposition-dissolution reaction of metallic lithium.

The lithium-ion secondary battery includes a cathode layer, an anode layer, and an electrolyte layer between the cathode layer and the anode layer.

In the present disclosure, the anode means one including an anode layer.

The term “fully charged state of the lithium-ion secondary battery” means a state in which the state of charge (SOC: State of Charge) of the lithium-ion secondary battery is 100%. SOC indicates a ratio of the charge capacity to the full charge capacity of the battery, and the full charge capacity is SOC 100%.

SOC may be estimated, for example, from an open circuit voltage (OCV: Open Circuit Voltage) of the lithium-ion secondary battery.

### Anode

The anode includes an anode layer. The anode optionally includes an anode current collector.

### Anode Current Collector

The material of the anode current collector may be a material that is not alloyed with Li, and examples thereof include SUS, copper, and nickel. Examples of the shape of the anode current collector include a foil shape and a plate shape. The shape of the anode current collector in plan view is not particularly limited, and examples thereof include a circular shape, an elliptical shape, a rectangular shape, and an arbitrary polygonal shape. The thickness of the anode current collector varies depending on the shape, but may be, for example, in a range of 1 μm to 50 μm or in a range of 5 μm to 20 μm.

### Anode Layer

The anode layers include Ag elements, Sn elements, and Li elements.

The anode layer may include a metal Sn layer including a single Sn and a metal Ag layer including a single Ag in order from the electrolyte layer prior to the first charge of the lithium-ion secondary battery.

The anode layer may include a Li—Sn alloy layer containing a Li—Sn alloy and a Li—Ag alloy layer containing a Li—Ag alloy in order from the electrolyte layer after the first charge of the lithium-ion secondary battery.

The anode layers may be free of Ag—C composites. That is, the anode layer may have a carbon content of 0 mass %.

The molar ratio (Sn/Ag) of Sn element to Ag element contained in the anode layer is 0.09 or higher and 0.17 or lower.

When the anode layer is equally divided into two portions parallel to the lamination surface of the anode layer, and the region on the anode current collector side is defined as the first region and the region on the electrolyte layer side is defined as the second region, the anode layer may have a larger content of Sn element in the second region than the content of Sn element in the first region. The parallel may be substantially parallel. It is only necessary to be substantially parallel within 0° to 10 degrees. The stacking direction of the anode layer is the thickness direction of the anode layer.

In comparing the contents of the two regions in the anode layer, for example, an SEM-EDX may be used to map elements from the electrolyte layer to the anode current collector as viewing fields, and the contents of the target elements in the respective regions may be compared. The comparison of the contents of the two regions in the anode layer may be performed on the lithium-ion secondary battery in a state such as a state at the time of full charge after the initial charge. The content is not limited to this, and XPS and TOF-SIMS may be used in addition to SEM-EDX.

Li content of Li—Ag alloy formed in the anode layer may be greater than or equal to 0 mol % and less than or equal to 100 mol %, and may be greater than or equal to 30 mol % and less than or equal to 99 mol %.

When the lithium-ion secondary battery is fully charged, Li content ratio of Li—Ag alloy produced in the anode layer may be 94 mol % or more and 97 mol % or less.

In Li—Ag alloy layers, the mean particle size of the grains of Li—Ag alloy may be greater than 0 μm and less than or equal to 5 μm.

In the anode layers, the volume occupied by Li—Ag alloy may be larger than 0 vol % and smaller than 100 vol %, or may be 5 vol % or more and 80 vol % or less.

After the first charge of the lithium-ion secondary batteries, the thickness of the Li—Sn layer may be greater than 0 μm and less than or equal to 100 μm, and the lower limit may be 0.01 km or more, or 0.1 μm or more. The upper limit of the thickness of Li—Sn layers may be 15 μm or less, 0.7 μm or less, or 0.35 μm or less.

After the first charge of the lithium-ion secondary battery, the thickness of Li—Ag alloy-layer may be greater than 0 μm and less than or equal to 100 μm, and the lower limit may be 0.1 μm or more, and the upper limit may be 40 μm or less.

The metallic Ag layers are formed on, for example, an anode current collector. The process includes the process of placing Ag grains and pressing, the method of evaporation, the method of sputtering, PVD method, and the method of electroplated. Among them, a vapor deposition method or a sputtering method may be used. As a result, it is possible to suppress the adhesion of the metallic Ag layers to the anode current collector.

The metal Sn layers may be formed on the anode current collector side or the solid-electrolyte layer side in the same manner as described above for the metal Sn layers. Among them, a film may be formed on the solid electrolyte layer side. When the film is formed on the solid electrolyte side, the adhesion of the metallic Sn layer to the solid electrolyte layer is increased.

The thickness of the anode layers is not particularly limited, but may be 30 nm or more and 50 μm or less at the time of full charge after the first charge of the lithium-ion secondary batteries.

### Electrolyte Layer

The electrolyte layer may be a liquid-based electrolyte layer using an electrolyte solution as an electrolyte, or may be a solid electrolyte layer using a solid electrolyte as an electrolyte.

As the electrolytic solution, a conventionally known electrolytic solution used in a lithium-ion secondary battery can be used.

The solid electrolyte layer contains at least a solid electrolyte.

As the solid electrolyte to be contained in the solid electrolyte layer, a known solid electrolyte that can be used in a solid battery can be used as appropriate, and examples thereof include an oxide-based solid electrolyte and a sulfide-based solid electrolyte. In order to suppress the peeling of the anode layer from the solid electrolyte layer, a relatively soft sulfide-based solid electrolyte may be used as the solid electrolyte.

Examples of the sulfide-based solid electrolyte include a solid electrolyte including an Li element, an M element (M is at least one of P, As, Sb, Si, Ge, Sn, B, and Al, Ga, In), and an S element. The sulfide-based solid electrolyte may further contain at least one of an O element and a halogen element.

Examples of the sulfide-based solid electrolyte include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. Note that the description of “Li₂S—P₂S₅” means a material made of a raw material composition containing Li₂S and P₂S₅, and the same applies to other descriptions.

In addition, “X” in the above LiX represents a halogen element. As the halogen element, for example, F element, Cl element, Br element, I element, and the like. One or more LiX may be contained in the raw material composition containing LiX. When two or more kinds of LiX are included, the mixing ratio of two or more kinds is not particularly limited.

The molar ratio of each element in the sulfide-based solid electrolyte can be controlled by adjusting the content of each element in the raw material. In addition, the molar ratio and the composition of the respective elements in the sulfide-based solid electrolyte can be measured, for example, by ICP emission spectrometry.

The sulfide-based solid electrolyte may be sulfide glass, crystallized sulfide glass (glass ceramics), or a crystalline material obtained by solid-phase reaction treatment of a raw material composition.

The crystalline state of the sulfide-based solid electrolyte can be confirmed, for example, by subjecting the sulfide-based solid electrolyte to powder X-ray diffraction measurement using CuKα rays.

The sulfide glass can be obtained by subjecting a raw material composition (for example, a mixture of Li₂S and P₂S₅) to amorphous processing. Examples of amorphous processing include mechanical milling.

The glass ceramics can be obtained, for example, by applying heat treatment to sulfide glass.

The heat treatment temperature may be any temperature higher than the crystallization temperature (Tc) observed by thermal analysis measurement of sulfide glass, and is normally 195° C. or higher. On the other hand, the upper limit of the heat treatment temperature is not particularly limited.

The crystallization temperature (Tc) of sulfide glass can be measured by differential thermal analysis (DTA).

The heat treatment time is not particularly limited as long as it is a time at which the desired crystallinity of the glass ceramic can be obtained, but is, for example, within a range of 1 minute to 24 time, and among them, within a range of 1 minute to 10 time.

The method for heat treatment is not particularly limited, but may be, for example, a method using a firing furnace.

Examples of the oxide-based solid electrolyte include a material having a garnet-type crystal structure having a Li element, a La element, an element A (A is at least one of Zr, Nb, Ta, and Al), and an element O. Examples of the oxide-based solid electrolyte include Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The shape of the solid electrolyte may be particulate from the viewpoint of ease of handling.

The mean particle size (D50) of the particles of the solid-state electrolyte is not particularly limited, but the lower limit is 0. The thickness may be 5 μm or more, and the upper limit may be 2 μm or less.

In the present disclosure, unless otherwise specified, the average particle diameter of particles is a volume-based median diameter (D50) measured by laser diffraction and scattering particle diameter distribution measurement. In the present disclosure, the median diameter (D50) is a diameter (volume average diameter) at which the cumulative volume of particles is half (50%) of the total volume when the particles are arranged in order from the smallest particle diameter.

The solid electrolyte can be used singly or in combination of two or more. Further, when two or more kinds of solid electrolytes are used, two or more kinds of solid electrolytes may be mixed, or two or more layers of each solid electrolyte may be formed to form a multilayer structure.

The proportion of the solid electrolyte in the solid electrolyte layer is not particularly limited. The proportion of the solid electrolyte in the solid electrolyte layer is, for example, 50% by mass or more, and may be in a range of 60% by mass or more and 100% by mass or less, may be in a range of 70% by mass or more and 100% by mass or less, or may be 100% by mass.

The solid electrolyte layer may contain a binder from the viewpoint of exhibiting plasticity or the like. Examples of such a binder include materials exemplified as a binder used in a cathode layer to be described later. However, in order to facilitate achieving high output, the amount of the binder to be contained in the solid electrolyte layer may be 5% by mass or less from the viewpoint of preventing excessive aggregation of the solid electrolyte and enabling formation of a solid electrolyte layer having a solid electrolyte uniformly dispersed therein.

The thickness of the solid electrolyte layer is not particularly limited, and is usually 0.1 μm or more and 1 mm or less.

### Cathode

The cathode includes a cathode layer. The cathode optionally includes a cathode current collector.

### Cathode Layer

The cathode layer includes a cathode active material capable of absorbing and desorbing lithium ions, and may include a solid electrolyte, a conductive material, a binder, and the like as optional components.

The cathode active material may include a Li element prior to the first charge of the lithium-ion secondary battery. The active material is, for example, lithium nickel cobalt aluminum oxide (NCA), LiCoO₂, LiNiₓCo₁₋ₓO₂ (0<x<1), LiNi_{1/3}Co_{1/3}Mn_{1/3}O₂, LiMnO₂, LiMn₂O₄, LiNiO₂, LiVO₂, heterogeneous element-substituted Li—Mn spinel, lithium titanate. It can be mentioned that metal lithium phosphate, lithium metal phosphate, LiCoN, Li₂SiO₃, and Li₄SiO₄, and the like. The heterogeneous element-substituted Li—Mn spinel includes, for example, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. Lithium titanate includes, for example, Li₄Ti₅O₁₂. Lithium metal phosphate includes, for example, LiFePO₄, LiMnPO₄, LiCoPO₄, and LiNiPO₄.

The shape of the cathode active material is not particularly limited, but may be particulate (cathode active material particles).

A Li ion-conductive oxide may be formed on the cathode active material. This is because the reaction between the cathode active material and the solid electrolyte can be suppressed. Examples of Li ion-conductive oxide include LiNbO₃, Li₄Ti₅O₁₂, and Li₃PO₄. The thickness of the coating layers is, for example, 0.1 nm or more, and may be 1 nm or more. On the other hand, the thickness of the coating layers may be, for example, less than or equal to 100 nm and less than or equal to 20 nm. The coating ratio of the coating layer on the surface of the cathode active material is, for example, 70% or more, and may be 90% or more.

Examples of the solid electrolyte include a solid electrolyte that can be contained in the above-described solid electrolyte layer.

The content of the solid electrolyte in the cathode layer is not particularly limited, but may be, for example, within a range of 1 mass % to 80 mass %, where the total mass of the cathode layer is 100 mass %.

As the conductive material, a known material can be used, and examples thereof include carbon materials and metal particles. Examples of the carbon material include acetylene black (AB), furnace black, VGCF, carbon nanotubes, and carbon nanofibers. Among the above, from the viewpoint of electron conductivity, at least one selected from the group consisting of VGCF, a carbon nanotube, and a carbon nanofiber may be used. Examples of metal particles include particles of Ni, Cu, Fe, and SUS.

The content of the conductive material in the cathode layer is not particularly limited.

Examples of the binder include acrylonitrile butadiene rubber (ABR), butadiene rubber (BR), polyvinylidene fluoride (PVdF), polytetrafluoroethylene (PTFE), and styrene butadiene rubber (SBR). The content of the binder in the cathode layer is not particularly limited.

The thickness of the cathode layer is not particularly limited.

The cathode layer can be formed by a conventionally known method.

For example, a slurry for a cathode layer is prepared by charging a cathode active material and, if necessary, other components into a solvent and stirring, and the slurry for a cathode layer is coated on one surface of a support such as a cathode current collector and dried to obtain a cathode layer.

Solvents include, for example, butyl acetate, butyl butyrate, heptane, and N-methyl-2-pyrrolidone.

The method of applying the slurry for the cathode layer on one surface of a support such as a cathode current collector is not particularly limited. Examples of a method of applying a slurry for a cathode layer on one surface of a support such as a cathode current collector include a doctor blade method, a metal mask printing method, an electrostatic coating method, a dip coating method, a spray coating method, a roll coating method, a gravure coating method, and a screen printing method.

As the support body, a support body with self-supporting properties can be appropriately selected and used, and there is no particular limitation. For example, metal foils such as Cu and Al can be used.

### Cathode Current Collector

As the cathode current collector, a known metal that can be used as a current collector of a lithium-ion secondary battery can be used. As the metals above, a metal material containing one or more elements selected from the group consisting of Cu, Ni, Al, V, Au, Pt, Mg, Fe, Ti, Co, Cr, Zn, Ge, and In can be exemplified. Examples of cathode current collectors include SUS, aluminum, nickel, iron, titanium, and carbon.

The shape of the cathode current collector is not particularly limited, and various shapes such as a foil shape and a mesh shape can be used.

The lithium-ion secondary battery includes an exterior body that houses a cathode layer, an anode layer, an electrolyte layer, and the like, if necessary.

The material of the exterior body is not particularly limited as long as the material is stable in the electrolyte. Examples thereof include polypropylene, polyethylene, and resins such as acrylic resins.

As the shape of the lithium-ion secondary battery, for example, coin-type, laminate-type, cylindrical, and square-type, and the like can be listed.

The lithium-ion secondary battery may be a liquid-based lithium-ion secondary battery using an electrolyte solution as an electrolyte, or a solid-state lithium-ion secondary battery using a solid electrolyte as an electrolyte. Applications of lithium-ion secondary batteries include, for example, hybrid electric vehicle (HEV), plug-in hybrid electric vehicle (PHEV), battery electric vehicle (BEV), gasoline-powered vehicles, and power supplies for vehicles such as diesel-powered vehicles. Among them, it may be used as a power source for driving hybrid electric vehicle (HEV), plug-in hybrid electric vehicle (PHEV), or battery electric vehicle (BEV). Further, the lithium-ion secondary battery may be used as a power source for a moving object (for example, a railway, a ship, or an aircraft) other than a vehicle, or may be used as a power source for an electric product such as an information processing apparatus.

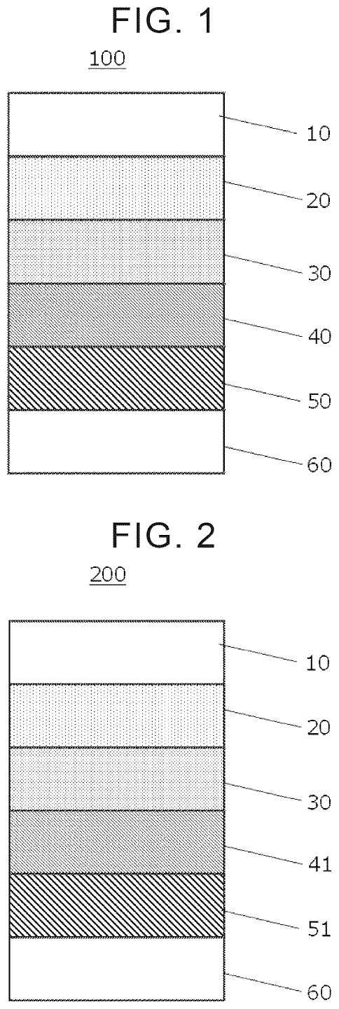

FIG. 1 is a schematic cross-sectional view showing an example of a lithium-ion secondary battery before initial charging at the time of manufacturing according to the present disclosure.

As illustrated in FIG. 1, the lithium-ion secondary battery 100 before the first charge includes a cathode current collector 10, a cathode layer 20, an electrolyte layer 30, a metal Sn layer 40, a metal Ag layer 50, and an anode current collector 60 in this order. The anode layer includes a metal Sn alloying layer 40 and a metal Ag layer 50.

FIG. 2 is a schematic cross-sectional view illustrating an example of the lithium-ion secondary battery at the time of full charge after the first charge according to the present disclosure.

As shown in FIG. 2, the lithium-ion secondary battery 200 after the initial charge includes the cathode current collector 10, the cathode layer 20, the electrolyte layer 30, Li—Sn alloy layer 41, Li—Ag alloy layer 51, and the anode current collector 60 in this order. Due to the initial charge, the metal Sn layer 40 becomes Li—Sn alloy layer 41, and the metal Ag layer 50 becomes Li—Ag alloy layer 51. The anode layer includes a Li—Sn alloy layer 41 and a Li—Ag alloy layer 51. The anode layer may be a single Li—Sn—Ag alloy layer in which Li—Sn alloy layer 41 and Li—Ag alloy layer 51 are mixed together.

### Embodiment 1 to 2

### Cathode Fabrication

Butyl butyrate was used as the solvent. NCA was used as the cathode active material. Particles of a sulfide-based solid electrolyte (average particle diameter: 2.0 μm) were used as the solid electrolyte. An Al foil was used as the cathode current collector. A cathode slurry was prepared by mixing a cathode active material, a solid electrolyte, a binder, and a conductive aid in the following mass composition ratio in a solvent.

Mass composition ratio cathode active material:solid electrolyte:binder:conductive auxiliary agent=84.7:13.4:0.6:1.27

The prepared cathode slurry was coated on an Al foil with a coating gap of 225 μm. Thereafter, the coated cathode slurry was temporarily dried at 60° C. for 3 hours. Thereafter, the temporarily dried cathode slurry was dried for 1 hour at 165° C. Thus, a cathode mixture coated foil with a weight basis of 18.7 mg/cm² and a design capacity of 3.0 mAh/cm² was obtained. The resulting cathode mixture coating foil was punched to obtain a cathode with a diameter of 11.28 mm.

### Solid Electrolyte Layer Preparation

Butyl butyrate was used as the solvent. Particles of a sulfide-based solid electrolyte (average particle diameter: 2.0 μm) were used as the solid electrolyte. A solid electrolyte slurry was prepared by mixing a solid electrolyte and a binder in a solvent at the following mass composition ratio.

Mass composition ratio solid electrolyte: Binder=92.6:7.4

The prepared solid electrolyte slurry was coated on a release film with a coating gap of 325 μm. Thereafter, the coated solid electrolyte slurry was temporarily dried at room temperature for 3 hours. Thereafter, the temporarily dried solid electrolyte slurry was dried at 165° C. for 1 hour. Solid electrolyte coating foil after drying was punched to obtain two discs with a diameter of 14.5 mm. The solid-electrolyte coated surfaces of the two disks were superimposed and pressed with a 7t. After the pressing, the release films of the two disks were peeled off to obtain a self-supporting solid electrolyte layer.

### Anode Fabrication

A Ni foil was used as the anode current collector. A metal Ag layer with a thickness of 0.368 μm for Example 1 and with a thickness of 0.735 μm for Example 2 was formed on one side of the anode current collector by sputtering to obtain a metal Ag layer/Ni foil. The obtained metal Ag layer/Ni foil was punched to obtain a metal Ag layer/Ni foil with a diameter of 14.5 mm.

A metal Sn layer with a thickness of 0.1 μm was formed on the solid electrolyte layer by sputtering to produce a solid electrolyte layer/metal Sn layer.

The obtained solid electrolyte layer/metal Sn layer and metal Ag layer/Ni foil were superposed in this order, and an anode (metal Sn layer/metal Ag layer/Ni foil) was obtained on the solid electrolyte layer.

### Cell Fabrication

Al was used as the cathode tub. Ni was used as the anode tub.

The produced cathode, the produced solid electrolyte layer, and the produced anode were arranged in this order to obtain a laminate. A cathode tab was attached to the cathode, and an anode tab was attached to the anode. Thereafter, the laminate was housed in a laminate film, and the inside of the laminate film was evacuated to seal the laminate. The sealed laminate was isotropically pressed with 392 MPa using a CIP (cold isotropic press) to produce a laminate cell (sometimes referred to as a cell). The laminated cell was restrained by 1 MPa using a constant pressure fixture in which a spring was inserted so that the restraining pressure became constant regardless of the volume change of the laminated cell.

### Comparative Example 1 to 2

A laminate cell was prepared in the same manner as in Example 1 except for the following. In the following, a metallic Sn layer is not formed on the solid-state electrolyte layer, and a metal Ag layer with a thickness of 0.368 μm for Comparative Example 1 and with a thickness of 0.735 μm for Comparative Example 2 was formed on one side of the anode current collector by sputtering to obtain a metal Ag layer/Ni foil that was used as an anode.

### Sn/Ag Molar Fraction

For the anode layer of 1 to 2 embodiment, the molar ratio (Sn/Ag) of Sn element to Ag element contained in the anode layer was calculated. The results are shown in Table 1.

### Initial Charge and Discharge

The laminated cells prepared in Example 1 to 2 and Comparative Example 1 to 2 were initially charged and discharged at 60° C. under the following conditions.

A constant current charge was performed under the conditions of a current density of 0.15 mA/cm² and a 0.05 C rate until a voltage of 4.2 V was reached, and then a constant voltage discharge was performed until a current density of 0.03 mA/cm² and a 0.01 C rate were reached.

A constant current discharge was performed under the conditions of a current density of 0.15 mA/cm² and a 0.05 C rate until a voltage of 3.0 V was reached, and then a constant voltage discharge was performed until a current density of 0.03 mA/cm² and a 0.01 C rate were reached.

### Resistance After Initial Charge/Discharge

In Example 1 to 2 and Comparative Example 1 to 2, resistance (Ω·cm²) when a predetermined current was supplied to the laminated cells after the first charging and discharging for 1 second at a predetermined voltage was measured by an AC impedance method. The results are shown in Table 1.

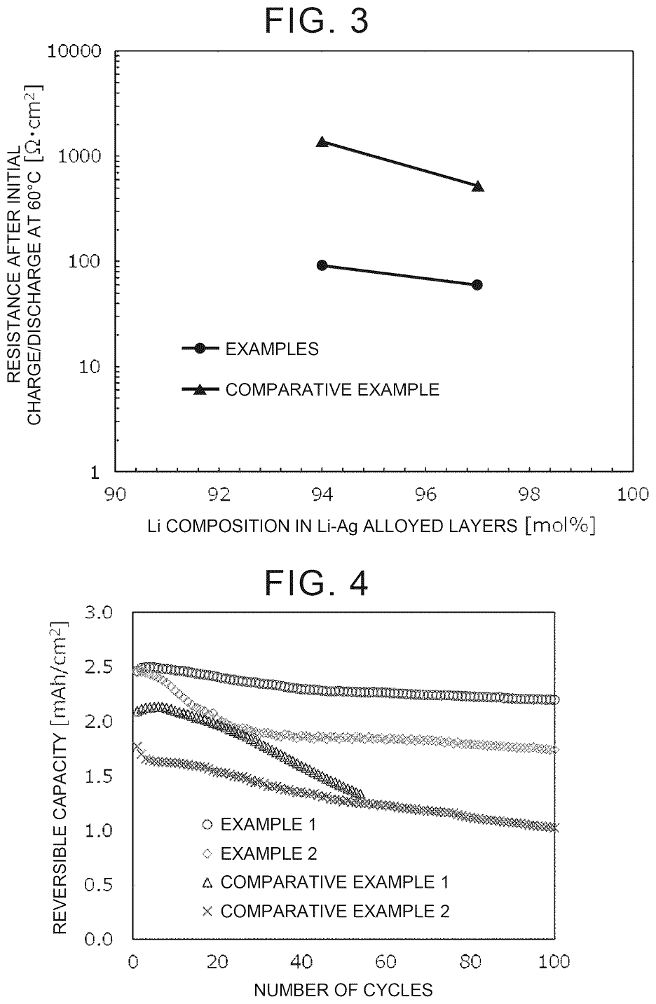

FIG. 3 is a graph showing the relation between Li content in Li—Ag layers and the resistivity of the laminated cells after the initial charge/discharge.

The resistance of the laminated cells of Example 1 to 2 after the first charge/discharge is reduced in the order of Example 2 and Example 1, and the resistance of the cells at the end of discharge is reduced as compared with the comparative example 1 to 2 in which Ag alone is used for the anode layers.

25° C. reversible capacity after initial charge/discharge at 60° C., and 25° C. reversible capacity after 50 cycles

Under the following conditions, the 25° C. reversible capacity (mAh/cm²) and the 25° C. reversible capacity (mAh/cm²) of the laminated cells after the first charging and discharging of Example 1 to 2 and Comparative Example 1 to 2 were measured at 25° C. after 50 cycles.

A constant current charge was performed under the conditions of a current density of 0.15 mA/cm² and a 0.05 C rate until a voltage of 4.2 V was reached, and then a constant voltage discharge was performed until a current density of 0.03 mA/cm² and a 0.01 C rate were reached.

Then, constant current discharge was performed under the conditions of a current density of 0.15 mA/cm² and a 0.05 C rate until the voltage reached 3.0 V, and the reversible capacity (discharge capacity) was measured. The charging and discharging were performed for 50 cycles, and the reversible capacity after 50 cycles was measured. The results are shown in Table 1.

FIG. 4 is a graph showing the relation between the reversible capacitance at 25° C. of the laminated cells after the charge-discharge cycles of Example 1 to 2 and Comparative Example 1 to 2.

In the 25° C. reversible capacity shown in FIG. 4, in Example 1 to 2, the sustaining rate of the reversible capacity is higher even if the number of charge/discharge cycles is increased than in Comparative Example 1 to 2.

The reversible capacity of the laminated cells of Example 1 to 2 shown in Table 1 at 60° C. after the first charge/discharge at 25° C. and the reversible capacity after 50 cycles are increased in the order of Example 2 and Example 1.

TABLE 1

| | | | | Reversible | | |
|---|---|---|---|---|---|---|
| | | Li composition | Resistance | capacity | | |
| | | in Li-Ag | after | after initial | 25° C. | |
| | | alloyed | initial | charge/ | reversible | |
| | Before initial | layers after | charge/ | discharge | capacity after | Sn/Ag |
| | charge Anode | initial charge | discharge | at 25° C. | 50 cycles | Molar |
| | layer structure | [mol %] | [Ω · cm²] | [mAh/cm²] | [mAh/cm²] | ratio |
| Comparative | Ag 367 nm | 97 | 525 | 2.10 | 1.40 | — |
| Example 1 | | | | | | |
| Comparative | Ag 735 nm | 94 | 1376 | 1.77 | 1.27 | — |
| Example 2 | | | | | | |
| Example 1 | Sn 100 nm/ | 97 | 60 | 2.47 | 2.28 | 0.1722 |
| | Ag 367 nm | | | | | |
| Example 2 | Sn 100 nm/ | 94 | 91 | 2.45 | 1.85 | 0.0861 |
| | Ag 735 nm | | | | | |

### Measuring SEM-EDX

The cross section of the solid electrolyte layer-anode (Li—Sn alloy layer/Li—Ag alloy layer/Ni foil) after the first charge of the laminated cell of Example 2 was subjected to SEM observation and EDX mapping in a secondary electronic image 5 kV an applied voltage.

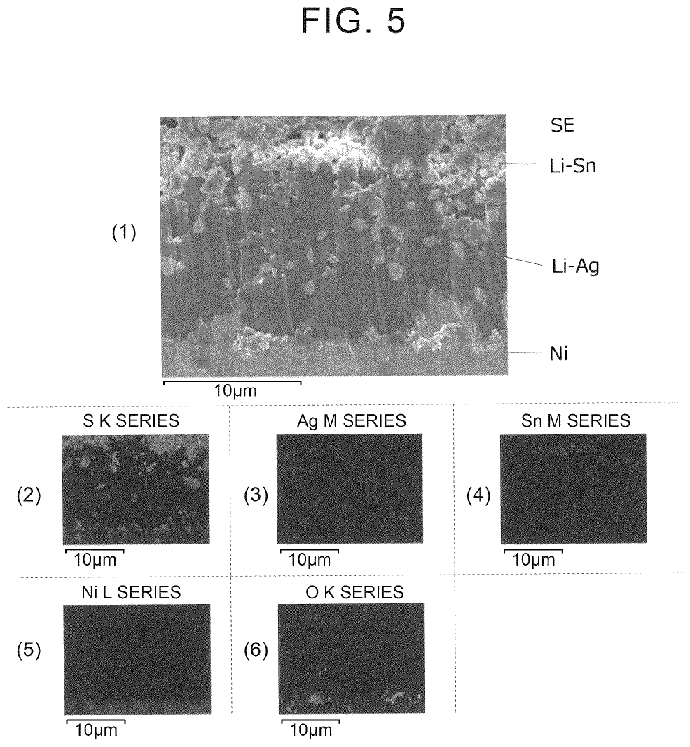

FIG. 5 shows (1) a secondary electronic image, (2) an S-element mapping, (3) Ag element mapping, (4) Sn element mapping, (5) Ni element mapping, and (6) O-element mapping in SEM-EDX mapping of the solid electrolyte layer-anode cross-section after the first charge of Example 2.

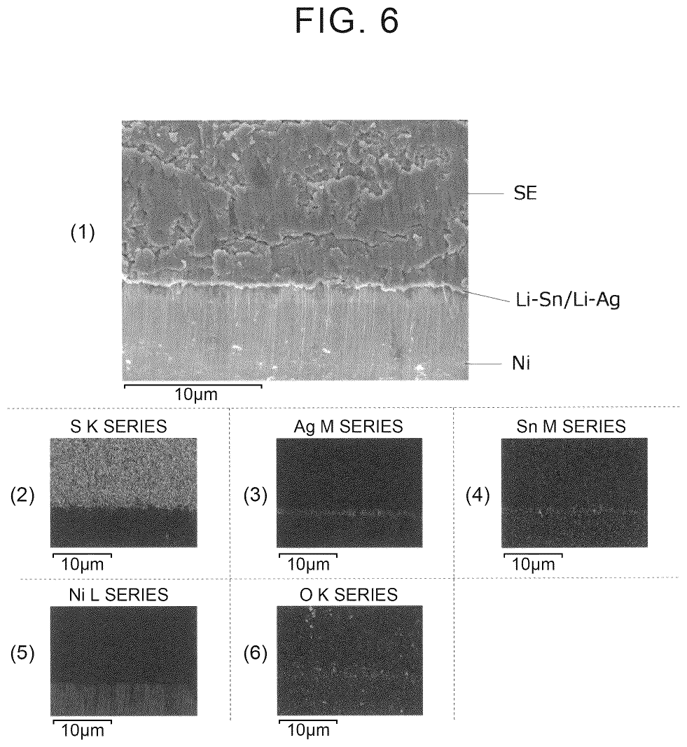

The cross section of the solid electrolyte layer-anode (Li—Sn alloy layer/Li—Ag alloy layer/Ni foil) after the first discharging of the laminated cell of Example 2 was subjected to SEM observation and EDX mapping in a secondary electronic image 5 kV an applied-voltage. FIG. 6 shows (1) a secondary electronic image, (2) an S-element mapping, (3) Ag element mapping, (4) Sn element mapping, (5) Ni element mapping, and (6) O-element mapping in SEM-EDX mapping of the solid electrolyte layer-anode cross-section after the first discharging of Example 2.

As shown in FIG. 5, when the anode layer is equally divided into two regions which are the region on the side of the anode current collector and the region on the side of the electrolyte layer, the content of Sn element in the region on the side of the electrolyte layer is larger than the content of Sn element in the region on the side of the anode current collector.

As shown in FIG. 5, after the first charge of the lithium-ion secondary battery, it can be seen that Li—Sn alloy layer is formed between the solid-state electrolyte layer and Li—Ag alloy layer. It was confirmed that the Li—Ag alloy layer was widely dispersed, that much Li reacted with Ag, and that the Li—Ag alloy layer functioned as a Li reaction layer.

As shown in FIG. 6, it can be seen that, in the end-of-discharge period of the lithium-ion secondary battery, Li—Sn alloy layer is maintained between the solid-state electrolyte layer and Li—Ag alloy layer even in the end-of-discharge period of the lithium-ion secondary battery. As a result, reduction decomposition of the solid-electrolyte layers by Li can be prevented, and an increase in the interfacial resistance and the cell resistance can be suppressed. In addition, it is considered that the adhesion between the solid-state electrolyte layer and the anode layer and the adhesion between Li—Sn alloy layer and Li—Ag alloy layer are improved when Li is discharged from the anode layer. In addition, it is considered that the resistance at the interface between the solid electrolyte layer and the anode layer decreases, the reversible capacity increases, and a decrease in the reversible capacity due to repetition of charging and discharging is suppressed.

What is claimed is:

1. A lithium-ion secondary battery that utilizes metal lithium deposition-dissolution reactions, the lithium-ion secondary battery comprising:
a cathode layer;
an anode layer; and
an electrolyte layer between the cathode layer and the anode layer, wherein:
the cathode layer includes a cathode active material that is arranged to absorb and desorb lithium ions;
the anode layer includes a silver element, a tin element, and a lithium element; and
a molar ratio of the tin element to the silver element contained in the anode layer is 0.09 or higher and 0.17 or lower.

2. The lithium-ion secondary battery according to claim 1, wherein:
the lithium-ion secondary battery includes an anode current collector on an opposite side of the anode layer from the electrolyte layer; and
when the anode layer is equally divided into two parts parallel to a layer surface of the anode layer, and a region on a side of the anode current collector is defined as a first region and a region on a side of the electrolyte layer is defined as a second region, content of the tin element in the second region of the anode layer is greater than content of the tin element in the first region of the anode layer.

3. The lithium-ion secondary battery according to claim 1, wherein, when the lithium-ion secondary battery is fully charged, a composition ratio of lithium in a lithium-silver alloy produced in the anode layer is 94 mol % or more and 97 mol % or less.

4. The lithium-ion secondary battery according to claim 3, wherein the electrolyte layer is a solid electrolyte layer containing a sulfide-based solid electrolyte.

5. A lithium-ion secondary battery that utilizes metal lithium deposition-dissolution reactions, the lithium-ion secondary battery comprising:
a cathode layer;
an anode layer; and
an electrolyte layer between the cathode layer and the anode layer, wherein:
the cathode layer includes a cathode active material that is arranged to absorb and desorb lithium ions;
the anode layer includes a metal tin layer containing elemental tin, and a metal silver layer containing elemental silver in order from a side of the electrolyte layer; and
a molar ratio of a tin element to a silver element contained in the anode layer is 0.09 or higher and 0.17 or lower.
